(19) United States
(12) Patent Application Publication
(10) Pub. No.: US 2008/0070213 A1
(43) Pub. Date: Mar. 20, 2008

(54) KARAOKE DEVICE WITH INTEGRATED MIXING, ECHO AND VOLUME CONTROL

(76) Inventor: Jack Strauser, Pinellas Park, FL (US)

Correspondence Address: LARSON AND LARSON, 11199 69TH STREET NORTH, LARGO, FL, 33773, US

(21) Appl. No.: 11/469,654

(22) Filed: Sep. 1, 2006

(51) Int. Cl. G09B 5/00

(52) U.S. Cl. 434/307 A

(57) ABSTRACT

A karaoke device is included within an enclosure and having a voice pickup element integrated into the enclosure for converting sound waves into an electrical signal. An audio input signal from a DVD player passes into the enclosure and into an electronic circuit for amplifying the electrical signal, for controlling the amplitude of the electrical signal and for mixing the electrical signal and the audio input signal into a mixed audio signal. The resulting audio output signal is delivered to an output device such as a television.

### BACKGROUND OF THE INVENTION

1. Field of the Invention

This invention relates to a karaoke device and more particularly to a karaoke device that works with an existing content source and output device such as a DVD player and television.

2. Description of the Related Art

Karaoke devices are well known in the industry. Generally, these devices include a source of music and lyrics that are played/displayed while the user(s) sing along. Early karaoke devices included a magnetic tape or compact disc with music recorded thereon. The music recorded is without vocal sound track or the vocal track is significantly muted so that the user can sing along with the music.

A professional karaoke system includes a source of music and lyrics, one or more microphones, a sound processing/amplification system for enhancing the user's voice and a display system for displaying lyrics and cues for the user(s). Some sound processing and amplification systems includes circuitry for adding echo to the user's voice and possibly additional circuitry to enhance the user's voice. It may also include a mixer for mixing the sound track with the user's voice. The display system is for displaying video information about the music, lyrics and a cue (e.g., color changes of lyrics) to help keep the user's singing on track with the music.

Home karaoke players have become popular in recent years. These systems include a player that accepts a microphone input and a karaoke disc or tape and mixes the user's voice with music from the disc, amplifies the sound and reproduces the sound with a speaker. One such system is described in U.S. Pat. No. 5,951,302 to Decker. There are several drawbacks to karaoke systems as described. The first drawback relates to having a separate device that duplicates many of the functions that are already performed by other components often found in homes and business. Many users already have a device that is capable of playing karaoke tapes or disks; for example, a CD player or DVD player. These users often have another device for amplifying and reproducing the music; for example, a stereo system or television. These users often have a device for displaying the lyrics and cues; for example, a television. Therefore, having another device that replicates many of these functions is wasteful and increases clutter. Another drawback to these types of systems is that the controls are often on the device, not the microphone. Being such, the user must approach the device with the microphone to adjust the volume, echo, etc, often causing undesirable feedback and noise. A third drawback is the requirement for a wire from the microphone to the karaoke device.

What is needed is a karaoke device that interfaces with a standard home CD/DVD player and television and provide all effects and controls within its housing.

### SUMMARY OF THE INVENTION

In one embodiment, a karaoke device is disclosed including an enclosure with a voice pickup element integrated into the enclosure, the voice pickup element for converting sound waves into an electrical signal. An audio input signal passing into the enclosure and into an electronic circuit for amplifying the electrical signal, for controlling the amplitude of the electrical signal and for mixing the electrical signal and the audio input signal into a mixed audio signal.

In another embodiment, a karaoke device is disclosed including an enclosure in the shape of a hand-held microphone with a voice pickup element integrated within the enclosure. The voice pickup element converts sound waves into an electrical signal. A left and right audio input signal passes into the enclosure on wires and is connected to an electronic circuit within the enclosure for amplifying the electrical signal, for controlling the amplitude of the electrical signal, for adding echo to the electrical signal, for mixing the electrical signal with the left audio input signal into a mixed left audio signal and for mixing the electrical signal with the right audio input signal into a mixed right audio signal.

In another embodiment, a karaoke device is disclosed including a voice pickup element integrated into a wireless microphone housing for converting sound waves into a first electrical signal. The first electrical signal is modulated onto a wireless signal within the wireless microphone housing and emitted by an antenna attached to the wireless microphone housing. A left and right audio input signal pass on a wire into an enclosure that has an electronic circuit for receiving the wireless signal and demodulating it into a second electrical signal, for controlling the amplitude of the second electrical signal, for adding echo to the second electrical signal, for mixing the second electrical signal with the left audio input signal into a mixed left audio signal and for mixing the second electrical signal with the right audio input signal into a mixed right audio signal.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a block diagram of a system of a first embodiment of the present invention.

FIG. 2 illustrates a block diagram of a system of a second embodiment of the present invention.

FIG. 3 illustrates a block diagram of a system of a third embodiment of the present invention.

FIG. 4 illustrates a schematic diagram of the first embodiment of the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures. In the following description, a DVD player is used as an example of a source of karaoke content (e.g., music with suppressed vocal tracks, lyrics and video) and a television or TV is used as an example of an output device that includes sound amplification and reproduction as well as video display. There are many other content sources such as personal computers, CD players, tape players, laser disc players, and the present invention is not limited in any way. There are many other output devices that include sound amplification and reproduction as well as a display, either in an integrated package or in individual components. Examples of such are stereo systems, monitors, personal computers, etc.

For simplicity, the block diagrams exclude a source of operating power. Power supplies including batteries and transformers are well known in the industry.

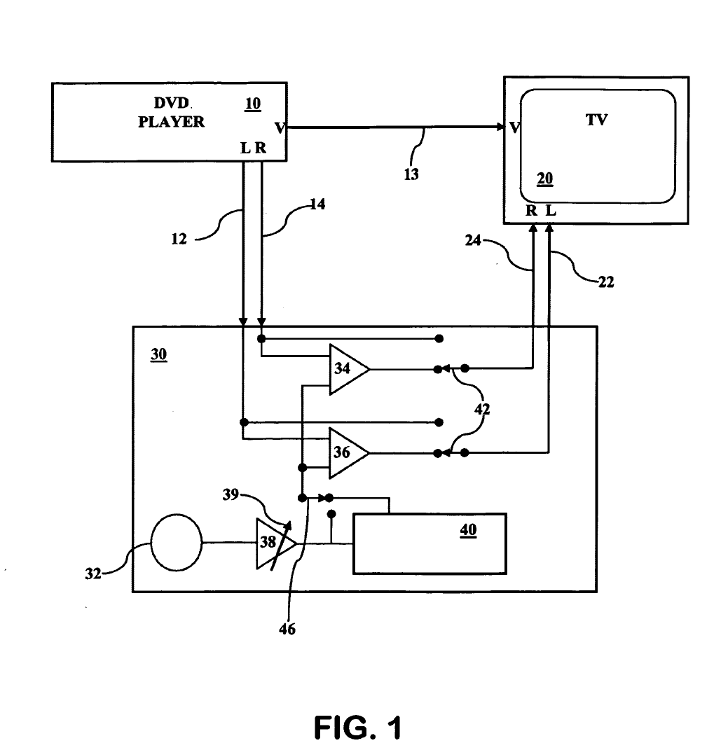

Referring to FIG. 1, a block diagram of a system of a first embodiment of the present invention is shown. In this example, a DVD player 10 has a video output 13 connected to a television 20. The left and right audio output from the DVD player 10 is connected to the karaoke device 30 with wires 12/14. The wires preferably have RCA phono plugs to plug into most standard audio output jacks included on DVD players. The karaoke device 30 is hand-held and preferably shaped similar to a standard microphone. A voice pick-up element 32 is situated on an outer surface of the karaoke device 30 in a location where it can receive sound waves corresponding to the user's voice. The voice pick-up element converts the sound waves into an electrical signal that is connected to an amplifier 38 that adjustably 39 amplifies the user's voice to a level compatible with the audio outputs 12/14 from the DVD player 10. In the preferred embodiment, the amplifier's output is adjusted by a multi-position switch connected to a resistor ladder. In other embodiments, the amplifier's output is adjusted with a potentiometer or a digital potentiometer having a volume-up and a volume-down push button switch. For most DVD players, the audio output level is usually around 1 volt, peak-to-peak.

The audio output signal from the adjustable amplifier 38 interfaces to a selector switch 46 and a sound processor 40. The sound processor 40 enhances the user's voice by adding, for example, echo. The selector switch 46 lets the user select either audio from the voice pick-up element 32 or from the sound processor 40. In some embodiments, the selector switch is integrated into an on/off power switch (not shown) having three positions such as off, on and on/echo.

The audio output from the selector switch is mixed with the left input 12 by amplifier 36 producing a mixed left audio signal and with the right input 14 by amplifier 34 producing a mixed right audio signal. The outputs of the amplifiers 34/36 pass to another selector switch 42 that selects to either pass the left and right audio from the DVD player 10 directly to the outputs or pass the mixed audio to the outputs. The outputs of the karaoke device 30 pass on cables 22/24 to the television 20. Again, it is preferred to have RCA phono jacks on the end of the cables 22/24 for compatibility with most televisions.

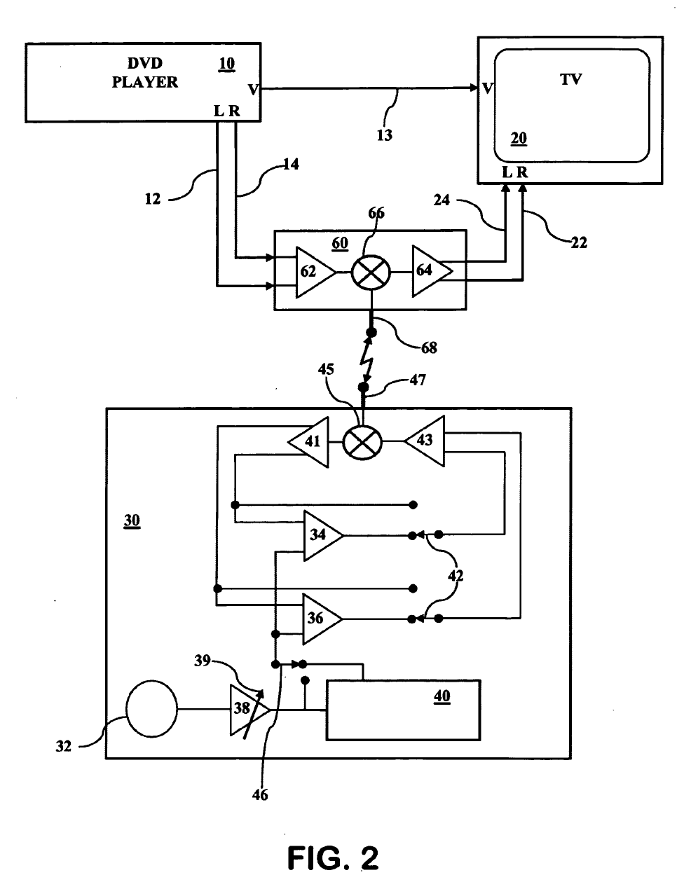

Referring to FIG. 2 illustrates a block diagram of a system of a second embodiment of the present invention is shown. In this example, a DVD player 10 has a video output 13 connected to a television 20. The left and right audio output from the DVD player 10 is connected to an audio transceiver 60 with wires 12/14. The wires preferably have RCA phono plugs to plug into most standard audio output jacks included on DVD players. The audio transceiver 60 has a modulator 62 (either analog or digital modulation) that modulates the left and right audio onto a wireless carrier such as a radio frequency or an infrared light frequency. Many methods of modulation such as Amplitude Modulation (AM), Frequency Modulation (FM) and Quadrature Modulation (QAM) are known in the industry and any can be used without veering from the present invention. In the example shown, the audio signals are modulated onto an RF signal that passes through an antenna mixer 66 to an antenna 68 where the modulated RF signal radiates and is picked up by an antenna 47 on the karaoke device 30.

The karaoke device 30 is hand-held and preferably shaped similar to a standard microphone. The modulated audio signal from the antenna 47 passes through an antenna mixer 45 and is demodulated by a demodulator 41 into left and right audio signals representative of the left and right audio signals from the DVD player 10. A voice pick-up element 32 is situated on an outer surface of the karaoke device 30 in a location where it can receive sound waves corresponding to the user's voice. The voice pick-up element is connected to an amplifier 38 that adjustably 39 amplifies the user's voice to a level compatible with the audio outputs 12/14 from the demodulator 41. In the preferred embodiment, the amplifier's output is adjusted by a multi-position switch connected to a resistor ladder. In other embodiments, the amplifier's output is adjusted with a potentiometer or a digital potentiometer having a volume-up and a volume-down push button switch. For most DVD players, the audio output level is usually around 1 volt, peak-to-peak.

The audio output signal from the adjustable amplifier 38 interfaces to a selector switch 46 and a sound processor 40. The sound processor 40 enhances the user's voice by adding, for example, echo. The selector switch 46 lets the user select either audio directly from the voice pick-up element 32 or from the sound processor 40. In some embodiments, the selector switch is integrated into an on/off power switch (not shown) having three positions such as off, on and on/echo.

The audio output from the selector switch is mixed with the left input by amplifier 36 and with the right input by amplifier 34. The outputs of the amplifiers 34/36 pass to another selector switch 42 that selects to either pass the left and right audio from the DVD player 10 to the outputs or pass the mixed audio to the outputs. The outputs of the karaoke device 30 are modulated in a similar way to the modulator in the audio transceiver 60 modulator 62 by another modulator 43. The modulated signal passes through the antenna mixer 45 and is radiated by the antenna 47. The radiated modulated audio signals are received by the audio transceiver's 60 antenna 68 and pass through the antenna mixer 66 and are demodulated by a demodulator 64. The audio output of the demodulator 64 passes on cables 22/24 to the television 20. Again, it is preferred to have RCA phono jacks on the end of the cables 22/24 for compatibility with most televisions.

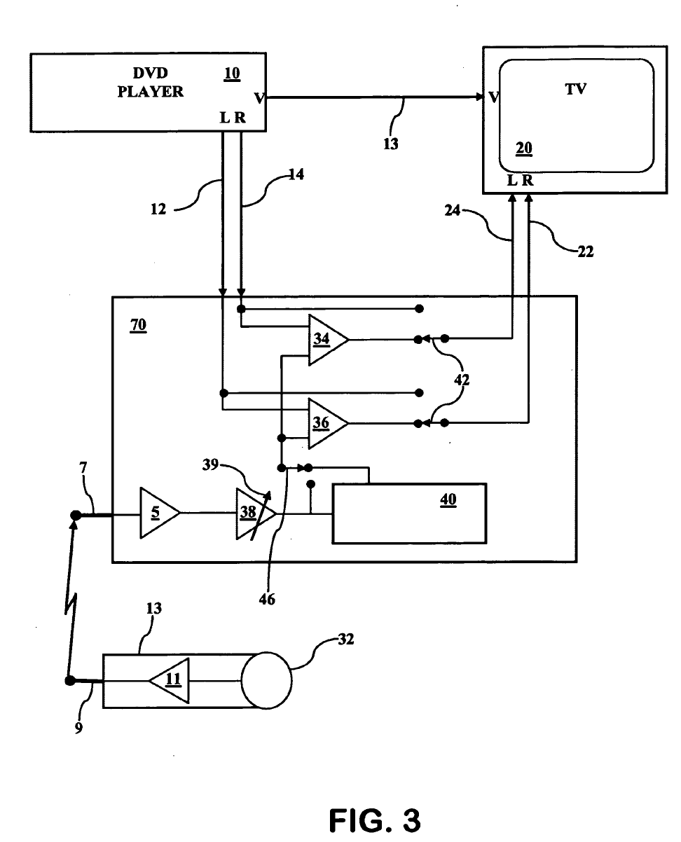

Referring to FIG. 3, a block diagram of a system of a third embodiment of the present invention is shown. In this example, a DVD player 10 has a video output 13 connected to a television 20. The left and right audio output from the DVD player 10 is connected to a base station karaoke device 70 with wires 12/14. The wires preferably have RCA phono plugs to plug into most standard audio output jacks included on DVD players. The base station karaoke device 70 is housed within an enclosure that can be located near the user's DVD player 10 and television 20.

A voice pick-up element 32 is situated on an outer surface of a wireless microphone 13 in a location where it can receive sound waves corresponding to the user's voice. The voice pick-up element converts the sound waves into an electrical signal that is connected to an amplifier and modulator 11 that amplifies the user's voice and modulates the audio signal onto a wireless signal (e.g., Radio Frequency or Infrared), emitting the wireless signal on an external antenna 9 or IR transducer (not shown). As discussed previously, any known method of modulation can be used to wirelessly send the user's voice (audio) to the base station karaoke device 70.

The wireless signal is picked up by a matching antenna (or IR transducer) 7 at the base station karaoke device 70 and demodulated by a demodulator 5 producing an electrical audio signal similar to the user's voice. This electrical signal is amplified by an amplifier 38 with volume control 39 to a level compatible with the audio outputs 12/14 from the DVD player 10. In the preferred embodiment, the amplifier's output (volume) is adjusted by a multi-position switch connected to a resistor ladder. In other embodiments, the amplifier's output is adjusted with a potentiometer or a digital potentiometer having a volume-up and a volume-down push button switch. For most DVD players, the audio output level is usually around 1 volt, peak-to-peak.

The audio output signal from the adjustable amplifier 38 interfaces to a selector switch 46 and a sound processor 40. The sound processor 40 enhances the user's voice by adding, for example, echo. The selector switch 46 lets the user select either audio from the voice pick-up element 32 or from the sound processor 40. In some embodiments, the selector switch is integrated into an on/off power switch (not shown) having three positions such as off, on and on/echo.

The audio output from the selector switch is mixed with the left input by amplifier 36 and with the right input by amplifier 34. The outputs of the amplifiers 34/36 pass to another selector switch 42 that selects to either pass the left and right audio from the DVD player 10 directly to the outputs or pass the mixed audio to the outputs. The outputs of the base station karaoke device 70 pass on cables 22/24 to the television 20. Again, it is preferred to have RCA phono jacks on the end of the cables 22/24 for compatibility with most televisions.

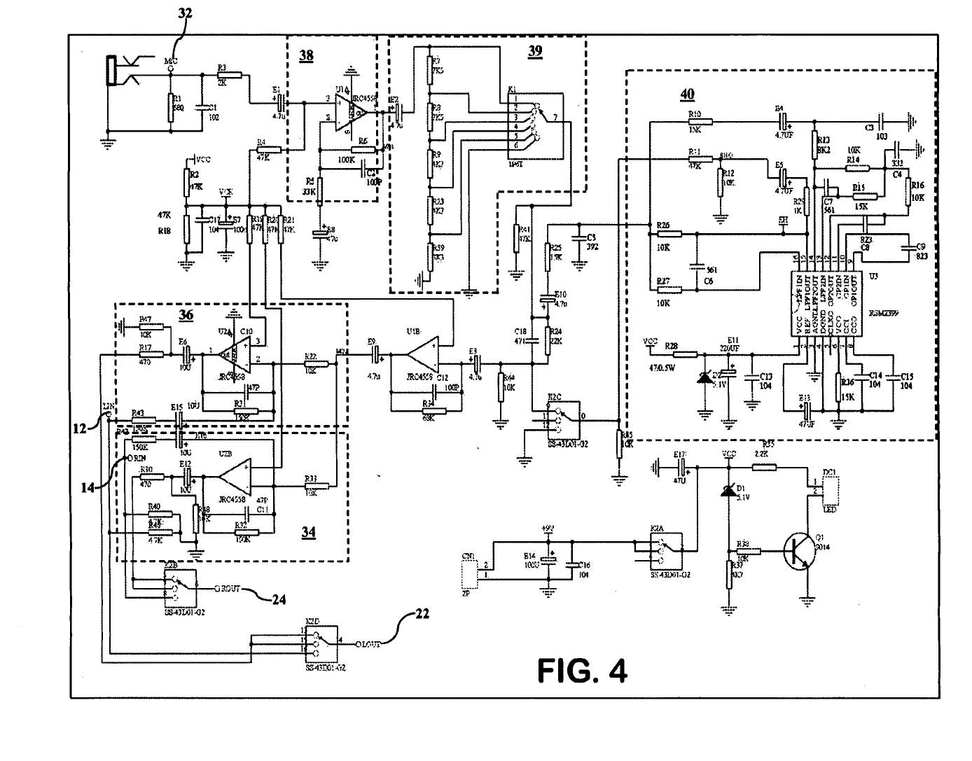

Referring to FIG. 4, a schematic diagram of a system of a first embodiment of the present invention is shown. In this exemplary design, the voice pick-up element or microphone 32 is connected to an amplifier 38 that amplifies the user's voice to a level compatible with the audio outputs 12/14 from the DVD player 10. In this exemplary design, the amplifier's 38 output is adjusted by a multi-position switch K1 39 connected to a resistor ladder (R7, R8, R9, R23, R39).

The audio output signal from the amplifier 38 interfaces to a selector switch (K2) and a sound processor 40. The sound processor 40 enhances the user's voice by adding echo processing. The selector switch (K2C) lets the user select either audio directly from the amplifier 38 (e.g., the voice from the microphone 32) or the processed audio from the sound processor 40. In this exemplary design, the selector switch is integrated into an on/off power (K2A) switch having three positions: off, on and on/echo.

The audio output from the selector switch is mixed with the left input 12 by amplifier 36 and with the right input by amplifier 34. The outputs of the amplifiers 34/36 pass to another selector switch (K2B and K2D) that selects to either pass the left and right audio from the left and right inputs 12/14 directly to the outputs 22/24 or pass the mixed audio to the outputs 22/24.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A karaoke device comprising:
an enclosure;
a voice pickup element integrated into the enclosure, the voice pickup element able to convert sound waves into an electrical signal;
an audio input signal passing into the enclosure; and
an electronic circuit within the enclosure for amplifying the electrical signal, for controlling the amplitude of the electrical signal and for mixing the electrical signal and the audio input signal into a mixed audio signal.

2. The karaoke device of claim 1, wherein the electronic circuit processes the electrical signal by adding echo.

3. The karaoke device of claim 1, wherein the amplitude of the electrical signal is controlled by a switch having at least three contacts, the at least three contacts connected to a resistor ladder.

4. The karaoke device of claim 2, further comprising a selector switch having at least three positions, a first of the three positions connecting the audio input signal directly to an audio output signal, a second of the three positions for connecting the mixed audio signal to the audio output signal and the third of the three positions connecting mixed audio signal and the echo to the audio output signal; the audio output signal passing out of the enclosure.

5. The karaoke device of claim 1, wherein the audio input signal is connected to at least one of a left output and a right output of a DVD player.

6. The karaoke device of claim 4, wherein the audio output signal is connected to at least one of a left audio input and a right audio input of a television.

7. The karaoke device of claim 1, wherein the enclosure is a hand-held microphone.

8. A karaoke device comprising:
an enclosure in the shape of a hand-held microphone;
a voice pickup element integrated into the enclosure, the voice pickup element able to convert sound waves into an electrical signal;
a left and right audio input signal passing on wires into the enclosure; and
an electronic circuit within the enclosure for amplifying the electrical signal, for controlling the amplitude of the electrical signal, for adding echo to the electrical signal, for mixing the electrical signal with the left audio input signal into a mixed left audio signal and for mixing the electrical signal with the right audio input signal into a mixed right audio signal.

9. The karaoke device of claim 8, wherein the amplitude of the electrical signal is controlled by a switch having at least three contacts, the at least three contacts connected to a resistor ladder.

10. The karaoke device of claim 8, further comprising a selector switch having at least three positions, a first of the three positions connecting the left audio input signal to a left audio output signal and connecting the right audio input signal to a right audio output signal, a second of the three positions for connecting the left mixed audio signal to the left audio output signal and connecting the right mixed audio signal to the right audio output signal and the third of the three positions connecting the left mixed audio signal and the echo to the left audio output signal and connecting the right mixed audio signal and the echo to the right audio output signal; the left and right audio output signal passing out of the enclosure on a second set of wires.

11. The karaoke device of claim 8, wherein the left audio input signal is connected to a left output of a DVD player and the right audio input signal is connected to a right output of the DVD player.

12. The karaoke device of claim 10, wherein the left audio output signal is connected to a left audio input of a television and the right audio output signal is connected to a right audio input of the television.

13. A karaoke device comprising:
an enclosure;
a voice pickup element integrated into a wireless microphone housing, the voice pickup element able to convert sound waves into a first electrical signal, the first electrical signal modulated onto a wireless signal within the wireless microphone housing and emitted by an antenna attached to the wireless microphone housing;
a left and right audio input signal passing on a wire into the enclosure; and
an electronic circuit within the enclosure for receiving the wireless signal and demodulating it into a second electrical signal, for controlling the amplitude of the second electrical signal, for adding echo to the second electrical signal, for mixing the second electrical signal with the left audio input signal into a mixed left audio signal and for mixing the second electrical signal with the right audio input signal into a mixed right audio signal.

14. The karaoke device of claim 13, wherein the amplitude of the second electrical signal is controlled by a switch having at least three contacts, the at least three contacts connected to a resistor ladder.

15. The karaoke device of claim 13, further comprising a switch having at least three positions, a first of the three positions connecting the left audio input signal to a left audio output signal and connecting the right audio input signal to a right audio output signal, a second of the three positions for connecting the left mixed audio signal to the left audio output signal and connecting the right mixed audio signal to the right audio output signal and the third of the three positions connecting the left mixed audio signal and the echo to the left audio output signal and connecting the right mixed audio signal and the echo to the right audio output signal; the left and right audio output signal passing out of the enclosure.

16. The karaoke device of claim 13, wherein the left audio input signal is connected to a left output of a DVD player and the right audio input signal is connected to a right output of the DVD player.

17. The karaoke device of claim 15, wherein the left audio output signal is connected to a left audio input of a television and the right audio output signal is connected to a right audio input of the television.

18. The karaoke device of claim 15, wherein the second position and the third position further connects the electronic circuit to a source of operating power.
